(19) United States
(12) Patent Application Publication
(10) Pub. No.: US 2025/0156686 A1
(43) Pub. Date: May 15, 2025

(54) Computer-Implemented Method for Detecting Deviations in a Production Process

(71) Applicant: Siemens Aktiengesellschaft, Muenchen (DE)

(72) Inventors: Jana EDER, Wien (AT); Martin JOKSCH, St.Andrä-Wördern (AT); Axel SÜNDERMANN, Wien (AT); Daniel SCHALL, Hollabrunn (AT)

(21) Appl. No.: 18/832,964

(22) PCT Filed: Jan. 25, 2023
(86) PCT No.: PCT/EP2023/051823

§ 371 Date: Jul. 25, 2024

(30) Foreign Application Priority Data
Jan. 26, 2022 (EP) 22153511.5

(51) Int. Cl. G06N 3/0455; G06N 3/048

(52) U.S. Cl. CPC G06N 3/0455; G06N 3/048

(57) ABSTRACT

A computer-implemented method for detecting deviations in a production process with process parameters includes providing reference process data of a reference production process which comprises reference parameters of the production process, generating and training a process model with model nodes and corresponding model weights based on an autoencoder using the reference process data, at least partly assigning model nodes of the process model to process parameters of the production process, providing current process data from a current production process that comprises current parameters of the production process, ascertaining process deviations of the current process data using the process model by determining a reconstruction error and outputting the model weights of the model nodes, estimating the future curve of the reconstruction error, and checking whether the estimated future curve of the reconstruction error lies within a specified value range for the specified duration and if so continuing, otherwise outputting an alarm.

### CROSS-REFERENCE TO RELATED APPLICATIONS

This is a U.S. national stage of application No. PCT/EP2023/051823 filed 25 Jan. 2023. Priority is claimed on European Application No. 22153511.5 filed 26 Jan. 2022, the content of which is incorporated herein by reference in its entirety.

### BACKGROUND OF THE INVENTION

### 1. Field of the Invention

The invention relates to a computer-implemented method, a computing device, a system for detecting deviations in a production process with process parameters, a computer program, an electronically readable data carrier and a data carrier signal, where a computing device with a memory is provided.

### 2. Description of the Related Art

Batch processes are generally found in industries that produce small quantities of materials that are produced by chemical, electrochemical or biological reactions. Controlling batch processes is a very complex and continuous process.

A “golden batch” is defined as a reference. The golden batch designation makes it possible to achieve a plant process operating curve that delivers optimum product blending together with improved end product quality.

Principal component analysis (PCA) is the tool used to analyze the data set. Principal component analysis (PCA) is used for dimensionality reduction. This means that the golden batch can be observed in real time in a 2D plot and, for example, the deviation of the 95% confidence interval (CI) from the golden batch can be ascertained. A deviation then indicates that it is necessary to intervene in the process.

However, current conventional methods can have disadvantages. For example, principal component analysis does not enable individual drift parameters to be identified, only complex subsequent statistical measurements.

Furthermore, it is often not possible to detect a single deviating process parameter or a small number of deviating process parameters, because they do not cause principal component analysis to exceed the limits of the analysis.

In addition, batch processes often have different maturation times because principal component analysis is calculated per time point, where it is necessary to take account of batch maturity.

### SUMMARY OF THE INVENTION

It view of the foregoing, it is therefore an object of the invention to provide a computer-implemented method, a computing device and a system for detecting deviations in a production process with process parameters that overcome the foregoing disadvantages.

This and other objects and advantages are achieved in accordance with the invention is achieved by a method comprising:
a) providing reference process data from a reference production process, which comprises reference parameters for the production process, to a computing device,
b) generating and training a process model with model nodes and assigned model weights based on an autoencoder using the reference process data,
c) at least partially assigning model nodes of the process model to process parameters of the production process,
d) providing current process data from a current production process, which comprises current parameters of the production process, to the computing device,
e) ascertaining process deviations of the current process data using the process model by determining a reconstruction error by the computing device, and outputting the model weights of the model nodes, as well as ascertaining individual contributions of model nodes to the process deviations and determining at least one individual contribution that lies outside a predetermined value range for the respective contribution,
f) estimating the future course of the reconstruction error from the currently determined reconstruction error and at least one previously determined reconstruction error for a predetermined duration and storing the reconstruction error in memory as at least one previously determined reconstruction error for a subsequent estimate,
g) checking whether the estimated future course of the reconstruction error for the predetermined duration lies within a predetermined value range and, if so, continuing with step d), otherwise outputting an alarm and transmitting the at least one individual contribution ascertained in step e) to the reference production process and using it in a subsequent production process in step d).

This makes it possible to identify individual deviations in process parameters.

It is further possible to capture the response time, i.e., the time it takes to take the corresponding necessary action.

In addition, a feedback loop with a control system is created in order to take appropriate action and allow feedback of drift parameters.

Therefore, in the event of an alarm, for example, the computing device can report to the production process via a feedback loop that the production process currently differs from the reference production process and corresponding action can be taken quickly so that the production process again approximates the reference production process. This occur via manipulated variables, for example, by adapting a machining speed within the reference production process.

This means that no further assessments of batch maturity are necessary.

An individual contribution of model nodes should be understood to be a subset of model nodes that are related to at least one process parameter of the production process. This makes it possible to act specifically and individually on a selected process parameter, for example, also a predetermined process parameter, for example, by identifying the model node that makes the most significant contribution to a process parameter, where the most significant contribution is, for example, identified by applying a predetermined value range for this contribution. Herein, a “logical” process parameter can be represented by one or more model nodes, where an overlap with other process parameters is also possible.

An autoencoder is an artificial neural network that is used to learn efficient encoding. An autoencoder aims to learn a compressed representation (encoding) for a data set and hence also to extract essential features. As a result, it can be used for dimensionality reduction.

An autoencoder uses three or more layers, i.e., an input layer with input nodes or neurons, some significantly smaller layers that form the encoding, and an output layer in which each neuron has the same meaning as the corresponding one in the input layer.

When linear neurons, i.e., linear model nodes, are used, an autoencoder is very similar to principal component analysis.

In one embodiment of the invention, non-linear model nodes are used in the autoencoder.

Non-linearity of neurons, i.e., non-linear model nodes, means that the output at any neuron cannot be reproduced from a linear function of the input. This is achieved by the use of a suitable activation function, such as a sigmoid function or a rectified linear unit (ReLU) function.

A sigmoid function, gooseneck function, Fermi function or S function is a mathematical function with an S-shaped graph. In general, a sigmoid function is a bounded and differentiable real function with a consistently positive or consistently negative first derivative and exactly one inflection point. Sigmoid functions can be used as activation functions in artificial neural networks, because the use of differentiable functions enables the use of learning mechanisms. As the activation function of an artificial neuron, the sigmoid function is applied to the sum of the weighted input values to obtain the output of the neuron.

In the context of artificial neural networks, a “rectifier” is an activation function of an artificial neuron. This activation function can be used to separate specific excitation and non-specific inhibition. Training deep networks with rectifying activation functions is more successful than, for example, it is with the sigmoid function. A unit that uses the rectifier is also referred to as a “rectified linear unit” (ReLU).

Non-linearity in activation functions in a neural network can generate a non-linear decision boundary via non-linear combinations of the weight and the inputs and, in contrast to principal component analysis, more complex non-linear relationships between the process parameters can be mapped.

In one embodiment of the invention, the at least one previously determined reconstruction error in step f) is zero if method step f) is executed for the first time.

In another embodiment of the invention, the estimation occurs with the aid of a regression method.

In a further embodiment of the invention, the process model further comprises input nodes with respective input weights, which are normalized over all input weights, and output nodes with respective output weights, which are normalized over all output weights, between which the model nodes are formed, and the at least one individual contribution of model nodes to the process deviations is ascertained in each case by comparing a model weight for at least one individual input node and at least one individual output node, which are normalized in each case over all input nodes or in each case over all output nodes, with a respective predetermined value range for the respective model weight, and the at least one individual contribution corresponds to at least the node whose weight lies within the predetermined value range.

The objects and advantages are also achieved in accordance with the invention by a computing device for detecting deviations in a production process with process parameters comprising a computing device with a memory which is configured to execute the method in accordance with disclosed embodiments of the invention.

The objects and advantages are also achieved in accordance with the invention by a system for detecting deviations in a production process with process parameters comprising a production plant and a device in accordance with the invention.

The objects and advantages in accordance with the invention are additionally achieved by a computer program comprising instructions which, when executed by a computer, cause the computer to execute the method in accordance with disclosed embodiments of the invention.

The objects and advantages in accordance with the invention are further achieved by a non-transitory electronically readable data carrier with readable control information stored thereon, which comprises at least the computer program in accordance with the invention and is configured such that, when the data carrier is used in a computing facility, it performs the method in accordance with disclosed embodiments of the invention.

The objects and advantages in accordance with the invention are also achieved by a data carrier signal that transfers the computer program according to the invention.

Other objects and features of the present invention will become apparent from the following detailed description considered in con-unction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention is explained in more detail below with reference to an exemplary embodiment depicted in the attached drawings, in which:

FIG. 1 shows an exemplary embodiment of a flow chart of the method in accordance with the invention;

FIG. 2 shows an exemplary embodiment of a system in accordance with the invention; and

FIG. 3 shows an exemplary autoencoder process model.

### DETAILED DESCRIPTION OF THE EXEMPLARY EMBODIMENTS

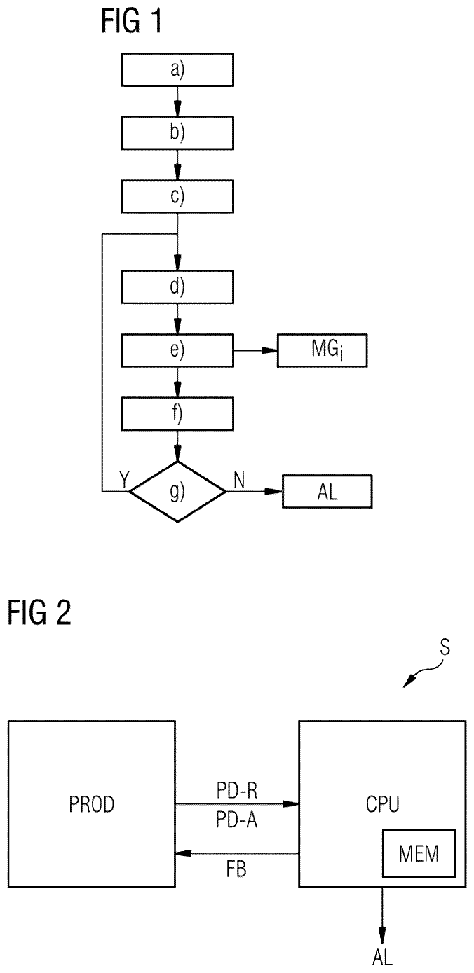

FIG. 1 shows an exemplary embodiment of a flow chart for the method in accordance with the invention.

The method for detecting deviations in a production process with process parameters is computer-implemented in a computing device CPU with a memory MEM.

A process parameter can, for example, be the operating temperature, operating pressure, power consumption or product properties of the product in question, such as the captured dimensions of the product in question.

A process parameter can be captured by a measured variable with the aid of a corresponding sensor via a computing device and controlled by a manipulated variable with the aid of a corresponding actuator, for example, by a computing device.

The production process with process parameters can, for example, have a plurality of process steps that can be configured individually or jointly by the process parameters.

However, it is also possible that the process parameters only specify a single process step.

Combinations of a plurality of process parameters with one or more process steps are also possible.

Herein, the following steps are executed:
a) providing reference process data from a reference production process, which comprises reference parameters for the production process, to the computing device CPU,
b) generating and training a process model PM with model nodes MKᵢ and assigned model weights MGᵢ based on an autoencoder using the reference process data, where the autoencoder is based on linear or non-linear model nodes MKᵢ,
c) at least partially assigning model nodes of the process model to process parameters of the production process,
d) providing current process data from a current production process, which comprises current parameters of the production process, to the computing device CPU,
e) ascertaining process deviations of the current process data using the process model by determining a reconstruction error and outputting the model weights MGᵢ of the model nodes MKᵢ, as well as ascertaining individual contributions of model nodes to the process deviations and determining at least one individual contribution that lies outside a predetermined value range for the respective contribution,
f) estimating the future course of the reconstruction error from the currently determined reconstruction error and at least one previously determined reconstruction error for a predetermined duration and storing the reconstruction error in the memory MEM as at least one previously determined reconstruction error for a subsequent estimate,
g) checking whether the estimated future course of the at least one individual contribution reconstruction error for the predetermined duration lies within a predetermined value range and, if so, continuing with step d), otherwise outputting an alarm AL and transmitting the at least one individual contribution ascertained in step e) to the reference production process and using it in a subsequent production process in step d).

Steps d) to g) form a conditional repetition loop.

The transmission of the at least one individual contribution ascertained in step e) to the reference production process and its use in a subsequent production process in step d) represents a further repetition loop, which, for purposes of clarity, is not depicted separately in the figure.

In the first pass, there is no previously determined reconstruction error in the memory MEM. Therefore, the at least one previously determined reconstruction error in step f) is assumed to be zero if step f) is executed for the first time. This corresponds to the assumption that the reference production process in step a) forms the reference variable and therefore does not yet show any deviation.

The estimation occurs, for example, with the aid of a regression method.

It is particularly advantageous to use non-linear model nodes MKᵢ for the autoencoder, because this allows a non-linear decision boundary to be generated via non-linear combinations of the weight and the inputs.

FIG. 2 depicts an exemplary embodiment of a system S in accordance with the invention.

A production plant PROD executes a production process and, herein, generates process data, for example, via sensors, and makes this process data available to a computing device CPU with a memory MEM.

On the one hand, the process data can be reference data PD-R, which is generated when a reference production process is executed.

On the other hand, the process data can be current process data PD-A, which is continuously generated during the execution of a reference production process and in each case maps a production process currently being executed.

If the check to determine whether the estimated future course of the reconstruction error for the predetermined duration lies within a predetermined value range produces a negative result, then an alarm AL is output.

Optionally, in the event of an alarm, the computing device CPU can report a corresponding control operation to the production plant PROD, i.e., the production process, via a feedback loop FB and this should lead to a reduction in the reconstruction error.

The feedback loop FB can also only transmit raw data from the procedure previously executed by the computing device CPU and the production plant PROD can ascertain and execute the necessary control operation itself.

The data ascertained by the method particularly includes the individual contributions of model nodes to the process deviations, because this enables targeted control of plant parts in order to improve the quality of production and reduce the reconstruction error.

This can, for example, be performed by ascertaining individual input nodes using their most significant input weights, i.e., those that are largest in terms of value.

A plurality of input nodes can, for example, form a “logical” input node to which a process variable can be assigned, such as a measured temperature or pressure value.

One or more individual contributions can be ascertained by checking whether a value lies outside a predetermined value range for the respective contribution.

If production is adapted accordingly by the feedback loop FB with one or more individual contributions and hence improved, then a reduction in the reconstruction error can be achieved for subsequent production processes.

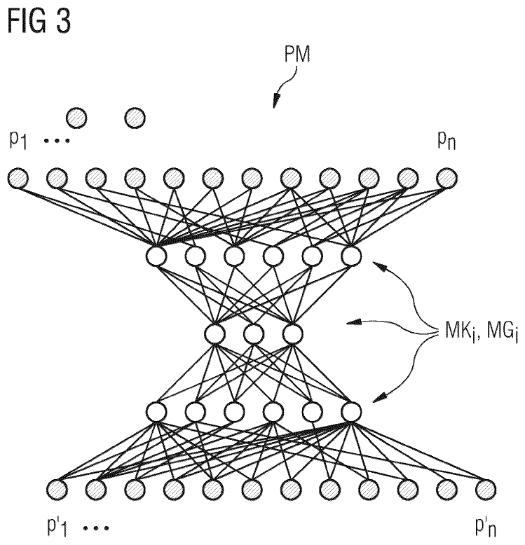

FIG. 3 shows an exemplary process model PM based on machine learning, specifically in the form of an autoencoder.

A plurality of input nodes with the input weights p₁-pₙ and output nodes with the output weights p′₁-p′ₙ are connected via a plurality of model nodes MKᵢ and in this way form an autoencoder.

Each model node MKᵢ, i.e., input node, output node and nodes of intermediate layers, in each case has an assigned model weight MGᵢ in the form of a numerical value.

The process model PM is generated and trained with the aid of process data from the production process.

The process data PD-R and PD-A can be generated via sensors and use corresponding numerical measured values to map states in the production process, such as operating temperature, operating pressure, power consumption, product properties of the manufactured product, such as captured dimensions of the manufactured product.

The reconstruction error RF can be ascertained in step e) by the following relationship:

$$RF = \sqrt{{( {p}_{1} - {{p}^{′}}_{1} )}^{2} + {( {p}_{2} - {{p}^{′}}_{2} )}^{2} + ⋯} \qquad Eq . l$$

The process model can have input nodes with respective input weights p₁-pₙ, which are normalized over all input weights p₁-pₙ, i.e., for example, all weights lie in a value range between 0 and 1.

Accordingly, this normalization can occur by relating the individual weights to the largest weight in terms of value.

The process model can further have output nodes with respective output weights p′₁-p′ₙ, which are normalized over all output weights p′₁-p′ₙ, i.e., for example, as before, all weights lie in a value range between 0 and 1.

The model nodes MKᵢ are formed between the input nodes and output nodes.

The individual contribution of model nodes to the process deviations can be ascertained in each case by comparing a model weight MGᵢ for an individual input node and an individual output node with a predetermined value range for the respective model weight.

The individual contribution corresponds, for example, to the node whose weight lies in the predetermined value range or the largest weight in terms of value is selected as the individual contribution.

Likewise, a plurality of weights can form a common “logical” weight, which can be selected as an individual contribution.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps that perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-10. (canceled)

11. A computer-implemented method for detecting deviations in a production process with process parameters, a computing device with a memory being provided, the method comprising:
a) providing reference process data from a reference production process, which comprises reference parameters for the production process, to the computing device;
b) generating and training a process model with model nodes and assigning model weights based on an autoencoder utilizing the reference process data;
c) at least partially assigning model nodes of the process model to process parameters of the production process;
d) providing current process data from a current production process, which comprises current parameters of the production process, to the computing device;
e) ascertaining process deviations of the current process data utilizing the process model by determining a reconstruction error and outputting the model weights of the model nodes, as well as ascertaining individual contributions of model nodes to the process deviations and determining at least one individual contribution which lies outside a predetermined value range for the respective contribution;
f) estimating a future course of the reconstruction error from the currently determined production error and at least one previously determined reconstruction error for a predetermined duration and storing the reconstruction error in the memory as at least one previously determined reconstruction error for a subsequent estimate; and
g) performing a check to determine whether the estimated future course of the reconstruction error for the predetermined duration lies within a predetermined value range and, if the estimated future course of the reconstruction error for the predetermined duration lies within the predetermined value range, continuing with step d), otherwise outputting an alarm and transmitting the at least one individual contribution ascertained in step e) to the reference production process and utilizing the at least one individual contribution ascertained in step e) in a subsequent production process in step d).

12. The method as claimed in the claim 11, wherein non-linear model nodes are utilized in the autoencoder aided by a sigmoid function or a rectified linear unit function.

13. The method as claimed in claim 11, wherein the at least one previously determined reconstruction error in step f) is zero if step f) is executed for the first time.

14. The method as claimed in claim 11, wherein the estimation occurs aided by a regression method.

15. The method as claimed in claim 11, wherein the process model further comprises input nodes with respective input weights which are normalized over all input weights, and output nodes with respective output weights which are normalized over all output weights, between which the model nodes are formed, and the at least one individual contribution of model nodes to the process deviations are each is ascertained by comparing a model weight for at least one individual input node and at least one individual output node, which are each normalized over all input nodes or over all output nodes, with a respective predetermined value range for the respective model weight, and the at least one individual contribution corresponds to at least the node whose weight lies within the predetermined value range.

16. A computing device for detecting deviations in a production process with process parameters comprising:
a memory;
wherein the computing device is configured to:
a) receive reference process data from a reference production process, which comprises reference parameters for the production process;
b) generate and train a process model with model nodes and assig model weights based on an autoencoder utilizing the reference process data;
c) at least partially assign model nodes of the process model to process parameters of the production process;
d) receive current process data from a current production process, which comprises current parameters of the production process;
e) ascertain process deviations of the current process data utilizing the process model by determining a reconstruction error and output the model weights of the model nodes, as well as ascertain individual contributions of model nodes to the process deviations and determine at least one individual contribution which lies outside a predetermined value range for the respective contribution;
f) estimate a future course of the reconstruction error from the currently determined production error and at least one previously determined reconstruction error for a predetermined duration and store the reconstruction error in the memory as at least one previously determined reconstruction error for a subsequent estimate; and
g) perform a check to determine whether the estimated future course of the reconstruction error for the predetermined duration lies within a predetermined value range and, if the estimated future course of the reconstruction error for the predetermined duration lies within the predetermined value range, continue with step d), otherwise output an alarm and transmit the at least one individual contribution ascertained in step e) to the reference production process and utilize the at least one individual contribution ascertained in step e) in a subsequent production process in step d).

17. A system for detecting deviations in a production process with process parameters comprising a production plant and the device as claimed in claim 16.

18. A computer program comprising instructions which, when executed by a computer, cause the computer to execute the method as claimed in one of claim 11.

19. A non-transitory electronically readable data carrier with readable control information stored thereon, which comprises at least a computer program which, when executed by a computer of a computing facility, causes detection of deviations in a production process with process parameters, the computer program comprising:
a) program instructions for providing reference process data from a reference production process, which comprises reference parameters for the production process, to a computing device;
b) program instructions for generating and training a process model with model nodes and assigning model weights based on an autoencoder utilizing the reference process data;
c) program instructions for at least partially assigning model nodes of the process model to process parameters of the production process;
d) program instructions for providing current process data from a current production process, which comprises current parameters of the production process, to the computing device;
e) program instructions for ascertaining process deviations of the current process data utilizing the process model by determining a reconstruction error and outputting the model weights of the model nodes, as well as ascertaining individual contributions of model nodes to the process deviations and determining at least one individual contribution which lies outside a predetermined value range for the respective contribution;
f) program instructions for estimating a future course of the reconstruction error from the currently determined production error and at least one previously determined reconstruction error for a predetermined duration and storing the reconstruction error in memory as at least one previously determined reconstruction error for a subsequent estimate; and
g) program instructions for performing a check to determine whether the estimated future course of the reconstruction error for the predetermined duration lies within a predetermined value range and, if the estimated future course of the reconstruction error for the predetermined duration lies within the predetermined value range, continuing with step d), otherwise outputting an alarm and transmitting the at least one individual contribution ascertained in step e) to the reference production process and utilizing the at least one individual contribution ascertained in step e) in a subsequent production process in step d).

20. A data carrier signal, which transfers the computer program as claimed in claim 18.
